(19) United States
(12) Patent Application Publication
(10) Pub. No.: US 2018/0103576 A1
(43) Pub. Date: Apr. 19, 2018

(54) SUPERABSORBENT POLYMER SEED COATING COMPOSITIONS

(71) Applicant: Seed Enhancements LLC, Caldwell, ID (US)

(72) Inventor: Steven M. Luttrell, Nampa, ID (US)

(21) Appl. No.: 15/784,948

(22) Filed: Oct. 16, 2017

Related U.S. Application Data
(60) Provisional application No. 62/481,365, filed on Apr. 4, 2017.
(60) Provisional application No. 62/408,370, filed on Oct. 14, 2016.

(51) Int. Cl. A01C 1/06; C09D 1/04; C09D 7/12; C09D 129/04; A01N 25/00

(52) U.S. Cl. CPC A01C 1/06; C09D 1/04; C09D 7/1216; C08K 2003/265; C09D 7/125; A01N 25/00; C09D 129/04

(57) ABSTRACT

Disclosed herein are several exemplary seed coating compositions, and exemplary methods for creating and using the same. Also disclosed are several exemplary seed coating manufacturing processes, and the products created by such processes. The seed coating compositions are for decreasing dusting and increasing the quality of coated seeds, and comprise an effective amount of clay mineral.

### TECHNICAL FIELD

The disclosure generally relates to the field of agricultural seed coating.

### BACKGROUND

Seed coatings have been used as means for protecting and enhancing the environment next to the pericarp of a seed, to control seed germination, and/or improve seedling survival and growth rate. Toward these ends, various additives have been included in seed coatings, including agrochemicals, Rhizobium bacteria, nutrients, beneficial elements, and plant growth regulators. Such additives can be effective in improving seed germination and seedling survival and growth in the face of diseases, insects, low soil pH, and poor soil fertility. By including these additives in seed coatings, the additives are placed at the interface between seed and soil. This close proximity to the interface between seed and soil maximizes the effect of the additives and reduces waste and environmental impact compared to the method of broadcasting such additives over a field containing uncoated seeds.

A common type of agent included in seed coatings is what is referred to as a water-absorbing additive, such as superabsorbent polymer. Water-absorbing additives readily swell, absorbing and retaining moisture after the seed has been planted in the ground. By bringing such moisture closer to the seed and holding the moisture there, the seed will more rapidly germinate.

To apply agents (including water-absorbing additives) to a seed or a coated seed to form a seed coating layer, a carrier must be utilized. Typically, the carrier is water or is water-based. After the seed coating layer is applied to the seed/coated seed, the seed/coated seed must then be dried to remove at least a portion of the carrier from the seed/coated seed. If the necessary portion of the carrier is not so removed, then the coated seeds may stick together, the coated seeds may mold while stored, and/or the coated seeds may germinate before planting.

When the carrier is of a type able to be absorbed by the water-absorbing additive (such as water), additional issues occur, namely, the water-absorbing additive absorbs a portion of the carrier (water). In absorbing the carrier, the water-absorbing additive swells. As the coated seed is then dried, and the water is removed from the coated seed, the water-absorbing additive shrinks. This swelling then shrinking process takes place during the drying process and damages the seed coating layer(s), causing damage to the seed coating layer, and resulting in portions of the seed coating layers flaking off (also known as “dusting”. It has been estimated that seventy five percent (75%) of the water-absorbing additive water-absorbing additive added to the seed coating frequently dusts off during the drying process.

This problem can be further compounded when limestone is used as one of the main ingredients in the coating. When that happens, the limestone likewise absorbs a portion of the carrier, resulting in increased dusting issues.

The end result of the current prior art process is frequently a dusty, undercoated, and less durable seed coating. Due to dusting off, the coated seeds have less water-absorbing additive attached to each seed and/or seeds will have differing amounts of water-absorbing additive attached thereto. Less water-absorbing additive results in a decreasing the amount of water available for storing around each seed after planting. Having less water available decreases seedling survival rates, especially when there are times of little or no water available after planting. Having differing amounts of water-absorbing additive means that different seedlings have differing chances of survival and abilities to flourish in the ground.

### SUMMARY OF THE DISCLOSURE

Disclosed herein are several exemplary superabsorbent polymer seed coating compositions, coated seeds, methods of producing coated seeds, seed coating manufacturing processes, methods of creating seed coating compositions, processes of coating seeds, and methods of using coated seeds created utilizing one of the same.

A first coated seed comprises a seed, and a seed coating on the seed. The coating comprises an inner coating layer of a clay mineral, and an outer coating layer of a water-absorbing additive. Preferably, the clay mineral is bentonite, preferably powdered bentonite. Preferably, the water-absorbing additive is a superabsorbent polymer. Preferably, a binder is used for binding the seed coatings to the seed. Preferably, the coating includes a later coating of at least one filler, preferably limestone. Preferably, the coating includes an additive.

An exemplary process of coating seeds comprises the steps of: providing a quantity of seeds; coating the seeds with a binder to create coated seeds; coating the coated seeds with a clay mineral and additional binder; coating the seeds with a water-absorbing additive; coating the seeds with a filler; coating the seeds with a filler and additional binder; compacting the coated seeds; and drying the coated seeds. Preferably, the clay mineral is bentonite clay, the water-absorbing additive is superabsorbent polymer, and the filler is limestone.

Additional understanding of the compositions, methods, processes and products contemplated and/or claimed by the inventor can be gained by reviewing the detailed description of exemplary devices and methods, presented below.

### Definitions

The use of “e.g.,” “etc,” “for instance,” “in example,” “for example,” and “or” and grammatically related terms indicates non-exclusive alternatives without limitation, unless otherwise noted. The use of “including” and grammatically related terms means “including, but not limited to,” unless otherwise noted. The use of the articles “a,” “an,” “the,” and “species” are meant to be interpreted as referring to the singular as well as the plural, unless the context clearly dictates otherwise. Thus, for example, reference to “clay mineral” includes two or more such clay minerals, and the like. The use of “optionally,” “alternatively,” and grammatically related terms means that the subsequently described element, event or circumstance may or may not be present/occur, and that the description includes instances where said element, event or circumstance occurs and instances where it does not. The use of “preferred,” “preferably,” and grammatically related terms means that a specified element or technique is more acceptable than another, but not that such specified element or technique is a necessity, unless the context clearly dictates otherwise. The use of “exemplary” means “an example of” and is not intended to convey a meaning of an ideal or preferred embodiment. Words of approximation (e.g., “substantially,” “generally”), as used in context of the specification, are intended to take on their ordinary and customary meanings which denote approximation, unless the context clearly dictates otherwise.

The use of “seed” means an embryonic plant enclosed in a protective outer covering, unless the context clearly dictates otherwise. The seeds with which the present invention is useful can be of any species. In some embodiments, the seed is grass seed (e.g., perennial ryegrass, fine fescue, Kentucky bluegrass, tall fescue, Bermuda grass, Zoysia grass, Bahiagrass, Centipede grass or mixtures thereof). In some embodiments, the seeds are for plant species that are agronomically important. These plant species include, but are not limited to, corn, peanut, canola/rapeseed, soybean, curcubits, crucifers, cotton, rice, sorghum, sugar beet, wheat, barley, rye, sunflower, tomato, sugarcane, tobacco, oats, as well as other vegetable crops, leaf crops and flower crops.

The use of “pericarp” means the outer protective covering of a seed, also known as a “seed coat,” unless the context clearly dictates otherwise.

The use of “agent” means a component of a seed treatment with which seeds are treated prior to planting, unless the context clearly dictates otherwise. Examples of agents include, but are not limited to clay minerals, water-absorbing additives, fillers, binders, and additives.

The use of “dusting” or “dusting off” means the process whereby agents in seed coatings dust, flake and fall off a coated seed during and after the drying process, including during storage and transportation, unless the context clearly dictates otherwise. Dusting can result in a multitude of problems, including the clogging of seed drills.

The use of “coated seed” means a seed coated with one or more layers of agents, unless the context clearly dictates otherwise.

The use of “seed coating” means the coating of a coated seed, comprising one or more layers of agents, unless the context clearly dictates otherwise.

The use of “inner layer” means a layer that is closer to the pericarp than an outer layer, unless the context clearly dictates otherwise. An inner layer does not necessarily need to be the layer covering the pericarp.

The use of “outer layer” means a layer that is farther from the pericarp than an inner layer, unless the context clearly dictates otherwise. The outer layer does not necessarily need to be the outermost layer.

The use of “seed coating layer” means a layer of one or more agents applied to a pericarp or coated seed, unless the context clearly dictates otherwise.

The use of “seed coating process” means any process that results in one or more agents and a seed or coated seed being brought together in such a way as to provide reasonably continuous contact between the agent and at least a portion of the seed or coated seed during the storage, transporting, and planting of the coated seed, unless the context clearly dictates otherwise. Many seed coating processes are known in the prior art, including but not limited to, true seed coating, seed pelleting, and film coating. “Coating” a seed or coated seed does not require that the agent(s) be uniformly distributed on the surface of the seed or coated seed; nor does “coating” require the entire surface of the seed or coated seed to be covered.

The use of “coating stabilizing layer” means a layer of clay mineral located between the pericarp and a layer of superabsorbent polymer, unless the context clearly dictates otherwise. One or more additional layers may exist between the coating stabilizing layer and the pericarp, and one or more additional layers may exist between the coating stabilizing layer and the layer of superabsorbent polymer.

The use of “clay mineral” means hydrous aluminum phyllosilicates, sometimes with variable amounts of iron, magnesium, alkali metals, alkaline earths, and other cations, unless the context clearly dictates otherwise.

The use of “bentonite” means an absorbent aluminum phyllosilicate clay mineral consisting mostly of montmorillonite, for example sodium bentonite, unless the context clearly dictates otherwise.

The use of “an effective amount of clay mineral to decrease the occurrence of dusting” means an effective amount of one or more clay minerals to stabilize the layer of superabsorbent polymer in a coating and decrease the occurrence of dusting, unless the context clearly dictates otherwise.

The use of “water-absorbing additive” means an additive able to absorb and retain water, unless the context clearly dictates otherwise. Examples of water-absorbing additives include, but not limited to, superabsorbent polymers.

The use of “superabsorbent polymer” means a polymer(s) which is adapted to imbibe or absorb, and retain, many times its own weight of fluid, such as water, unless the context clearly dictates otherwise. Superabsorbent polymers are also referred to as super-hydrating polymers, water-swellable polymers, and hydrogels.

The use of “filler” means an insoluble particulate material used to build-up the size of a coated seed, unless the context clearly dictates otherwise. Examples of fillers include, but are not limited to, limestone.

The use of “limestone” means calcium carbonate (CaCO₃) based inorganic material, unless the context clearly dictates otherwise.

The use of “binder” means any suitable binder approved for agricultural use, including, but not limited to binders, adhesives, polymers, resins and the like, dispersed or dissolved in a carrier, which are suitable for binding material to a pericarp or seed coating layer, unless the context clearly dictates otherwise. Examples of suitable binders include, but are not limited to binders selected from the group consisting of glues, stickers, water soluble adhesives, molasses, corn syrup, sorghum, cane syrup, polyvinyl alcohol, polyvinyl acetate, Arabic gums, polyvinyl pyrrolidone, calcium lignosulfonate, and synthetic organic polymers. A suitable binder should not impair seed germination, should give the seeds a durable coating when the seeds are dry, and should be readily soluble in water so that the coating will not stick on the pericarp or seed coating layer when the seeds are wet. Preferred binders are water-soluble, but binders which are not water-soluble could be utilized.

The use of “carrier” means an aqueous carrier such as water, one or more solvents, or a combination of water and one or more solvents, unless the context clearly dictates otherwise. A carrier is used to carry an agent.

The use of “layer” means a substantially solid coating disposed on at least a portion of a substrate, unless the context clearly dictates otherwise.

The use of “additive” means any additional material or component, including but not limited to Rhizobium bacteria, MYCO SEED TREAT®, nutrient components, pesticides, fungicides, herbicides, buffers, biologicals to protect a developing seedling, fillers, agrochemicals, beneficial elements, zeolite, soil surfactants (wetting agents), vitamins, cofactors, penetrants, water absorbants, mold inhibitors, soil conditioners (polyacrylamide) carbohydrates, acids, and plant growth regulators, unless the context clearly indicates otherwise.

The use of “MYCO SEED TREAT®” or “MST” means a dry blend of plant-beneficial bacteria and fungi (including Mycorrhizae) accompanied by a nutrient package to support the bacteria and fungi during their initial stages of growth, produced by AgriEnergy Resources L.L.C.

The use of “zeolite” means microporous, aluminosilicate minerals, including all natural and manmade species of zeolites, unless the context clearly dictates otherwise. The zeolite can be in the form of pure compound, technical grade of the compound, or a formulation of the compound.

The use of “nutrient component” means a substance that provides nourishment essential for growth and the maintenance of life, unless the context clearly indicates otherwise. Examples of nutrient components include, but are not limited to micronutrients, macronutrients, and nutrients selected from the group consisting of nitrogen (N), phosphorus (P), potassium (K), calcium (Ca), magnesium (Mg), sulfur (S), boron (B), copper (Cu), iron (Fe), chloride (Cl), manganese (Mn), molybdenum (Mo), and Zinc (Zn).

The use of “pesticide” means a substance used for destroying insects or other organisms harmful to cultivated plants, unless the context clearly indicates otherwise. Examples of pesticides include, but not limited to, pesticides selected from the group consisting of organophosphate pesticides, carbamate pesticides, organochlorine insecticides, pyrethroid pesticides, and microbial pesticides.

The use of “fungicide” means a chemical that destroys fungus, unless the context clearly indicates otherwise. Examples of fungicides include, but not limited to, systemic fungicides and fungicides selected from the group consisting of mancozeb, tricyclazole, carbendazim, hexaconazole, metalaxyl, benomyl, difenoconazole, propinconazole, kitazin, tebuconazole, copper oxychloride, copper hydroxide, tridemorph and propineb.

The use of “herbicide” means a substance that is toxic to plants and is used to destroy unwanted vegetation, unless the context clearly indicates otherwise. Examples of herbicides include, but not limited to, herbicides selected from the group consisting of phenoxy acid, benzoic acid, dinitroaniline, bipyridylium, substituted urea, and arsenical.

### DETAILED DESCRIPTION

The following description provides examples of that which the inventor regards as his invention. As such, the embodiments discussed herein are merely exemplary in nature and are not intended to limit the scope of the invention, or its protection, in any manner. Rather, the description of these embodiments serves to enable a person of ordinary skill in the relevant art to practice the invention.

The inventor has found that the aforementioned dusting off issue can be addressed by coating the seed with an inner coating stabilizing layer, for instance comprising a clay mineral, such as bentonite clay, before the seed is coated with additional layers of agents, including water-absorbing additives.

Without being bound by any particular theory, it is believed that coating the seed with a coating stabilizing layer before adding a coating layer containing superabsorbent polymer alters the exchange of water during the seed coating process, resulting in less damage to the seed coating during the drying process and less dusting. Explained a different way, the application of the inner coating stabilizing layer before application of water absorbing additives is believed to decrease dusting off by the inner coating stabilizing layer absorbing some of the excess water present in the binder, thereby decreasing the water available to the water-absorbing additive after the water-absorbing additive is applied, resulting in the water-absorbing additive having a better opportunity to adhere to the seed coating layer the water-absorbing additive was applied to.

By increasing the amount of water-absorbing additive attached to each seed, the amount of water available for storing around each seed after planting is increased. With more water stored next to a germinating seed, the chance that seedling will survive, especially when there are times of little or no water available after planting, increases. Further, by decreasing dusting off (the degree of which can vary from coated seed to coated seed), the water-absorbing additive and additives are more evenly spread throughout bags of seed, better ensuring the majority of seedlings will all have the same chance at surviving and flourishing.

Disclosed herein are several exemplary seed coating compositions, coated seeds, methods of producing coated seeds, seed coating manufacturing processes, methods of creating seed coating compositions, processes of coating seeds, and methods of using coated seeds created utilizing one of the same.

The exemplary seed coating compositions are for decreasing the occurrence of dusting in coated seeds, thereby increasing the quality of such coated seeds.

An exemplary seed coating composition comprises an inner coating stabilizing layer followed by a layer of superabsorbent polymer.

An exemplary coated seed comprises a seed, coating the seed with a coating stabilizing layer comprising bentonite clay to produce a stabilized seed unit, coating the stabilized seed unit with a superabsorbent polymer to produce a polymer coated seed unit, and coating the polymer coated seed unit with limestone to create the coated seed.

An exemplary method for producing coated seeds comprises coating seeds with the first exemplary seed coating composition.

An exemplary seed coating manufacturing processes comprises the step of coating a seed with a seed coating composition comprising bentonite.

An exemplary method of creating seed coating compositions comprises the step of coating a seed with a seed coating composition comprising bentonite.

An exemplary process of coating seeds, comprises the steps of providing a quantity of seeds, coating the seeds with a quantity of bentonite, compacting the coated seeds, drying the coated seeds, and screening the dried, coated seeds.

In an exemplary seed coating composition, the inner coating stabilizing layer comprises a clay mineral, such as bentonite. The inner coating stabilizing layer may be applied directly to the pericarp, or may be applied to a seed coating layer. The material comprising the inner coating stabilizing layer may be directly applied to the pericarp or seed coating layer, may be applied to the pericarp or seed coating layer via a carrier, or may be applied to the pericarp or seed costing layer along with a binder for binding the inner coating stabilizing later to the pericarp or seed coating layer. Application of the clay mineral to the pericarp or seed coating layer forming the inner coating stabilizing layer. One or more inner coating stabilizing layers may be applied. One or more layers of agents may be applied to the coated seed after the inner coating stabilizing layer is applied.

In an exemplary seed coating composition, the layer of water-absorbing additive is applied to a seed coating layer after the inner coating stabilizing layer is applied. The material comprising the layer of water-absorbing additive may be directly applied to the seed coating layer, may be applied to the seed coating layer via a carrier, or may be applied to the seed costing layer along with a binder for binding the water-absorbing additive to the seed coating layer.

In an exemplary seed coating composition, an outer layer of filler may be applied to the coated seed after the application of the water-absorbing additive and additional seed coating layers (if any). The purpose of the filler is to get the total weight (and size) of the coated seed to a desired weight/size for ease of planting. The filler is mixed with a water-based, water-soluble, polymer and applied to the pericarp or seed coating layer. The material comprising the filler may be directly applied to the seed coating layer, may be applied to the seed coating layer via a carrier, or may be applied to the seed costing layer along with a binder for binding the filler to the seed coating layer.

One example of a filler that can be utilized in exemplary seed coating compositions is calcium carbonate (limestone). Calcium carbonate could also be utilized as a pH buffer. An additional filler that can be utilized in exemplary seed coating compositions is bentonite. In some exemplary seed coating compositions, additional agents, such as bentonite or zeolite, can be added with the filler.

In exemplary seed coating compositions, any suitable binder may be used. The binder is for ensuring that the agent binds to the pericarp or seed coating layer.

In an exemplary seed coating composition, the binder can be added to seeds before they are coated with any agents, during the time when they are coated with agents, or after they have been coated with one or more agents. The binder can also be mixed together with one or more of the agents before coating the seeds or coated seeds with the mixture thereof.

Many techniques for applying coatings to seeds are known and may be used for coating seed with exemplary seed coating compositions, including, but not limited to, seed pelleting, film coating, and true seed coating.

Seed pelleting is the deposition of at least one layer of an inert material onto at least a portion of the seed, so as to substantially increase the weight of the seed, and to improve the plantability of the seed. The main application of seed pelleting is to pelletize seeds that are hard to singulate (e.g., small, light, variably-sized, and/or irregularly-shaped seeds) into spherical, or near-spherical, capsules configured for precision sowing. Instead of oversowing raw, uncoated seed, and then subsequently thinning established plants, which can be very costly when seeds and labor are expensive, pelleted seeds can be precisely planted to achieve uniform spacing. Due to their high operational cost, seed pelleting processes are mainly used in the vegetable and flower seed sectors.

Film coating is the application of a continuous layer of a film, such as a polymer film, over at least a portion of a seed to control product dust-off. Film coating is also used for seed cosmetics and variety identification (e.g., by color). Film coating is mainly applied on vegetable seeds, because the high cost of the film coating polymer does not justify its value on low value seeds.

True seed coating may be defined as the addition of at least one layer of a material or materials that would result in a significant increase in seed weight, and/or size increase to at least a portion of the seed, but where the coated seed still retains the same shape as the raw. True seed coating is mainly employed to coat small-seeded, forage legume seeds, and grass seeds. The main purposes of true seed coating are to improve seed plantability, and to incorporate seed treatment chemicals, nutrients, and beneficial elements into the seed coating so as to meet the seedlings' early needs. Moreover, true seed coating has been proven to be the most efficient way of inoculating small-seeded, forage legume seeds.

Various techniques and equipment known in the seed coating art may be used for applying a seed coating composition to a seed. The process may be continuous or batch and typically involves tumbling the seed in the presence of the coating composition. Some drying of the coated seed may be required.

In an exemplary seed coating composition, formulations of the agents and additives can be prepared by admixing the compound with one or more adjuvants including diluents, extenders, carriers, surfactants, and conditioning agents to provide compositions in the form of particulate solids, solutions, dispersions, or emulsions. Such compositions include, for example, wettable powders, granulars, dusts, emulsifiable concentrates, and flowables.

A first exemplary seed coating composition comprises an inner coating stabilizing layer followed by a layer of water-absorbing additive.

Another exemplary seed coating composition comprises the first exemplary seed coating composition where the inner coating stabilizing layer comprises an effective amount of clay mineral to decrease the occurrence of dusting.

Another exemplary seed coating composition comprises the first exemplary seed coating composition where the inner coating stabilizing layer comprises an effective amount of clay mineral to decrease the occurrence of dusting, wherein the clay mineral is bentonite.

Another exemplary seed coating composition comprises one of the above seed coating compositions where the inner coating stabilizing layer comprises an effective amount of clay mineral to decrease the occurrence of dusting, wherein the clay mineral is powdered bentonite.

Another exemplary seed coating composition comprises one of the above seed coating compositions wherein the water-absorbing additive comprises super-hydrating polymer.

Another exemplary seed coating composition comprises one of the above seed coating compositions wherein a binder is applied before, with or after the inner coating stabilizing layer.

Another exemplary seed coating composition comprises one of the above seed coating compositions wherein a binder is first applied to the pericarp of the seed, and once the seed has become saturated with the binder (for instance, when the seeds begin to adhere to one another), then powdered bentonite is layered onto the moistened seed.

Another exemplary seed coating composition comprises the previous seed coating composition, wherein the binder comprises one or more of the following: molasses, corn syrup, sorghum, cane syrup, polyvinyl alcohol, polyvinyl acetate, Arabic gums, polyvinyl pyrrolidone, calcium lignosulfonate, and synthetic organic polymers.

Another exemplary seed coating composition comprises one of the above seed coating compositions wherein the coating stabilizing layer comprises a clay mineral.

Another exemplary seed coating composition comprises one of the above seed coating compositions wherein the clay mineral comprises bentonite clay.

Another exemplary seed coating composition comprises one of the above seed coating compositions wherein the water-absorbing additive is a superabsorbent polymer.

Another exemplary seed coating composition comprises one of the above seed coating compositions wherein the filler is limestone.

Another exemplary seed coating composition comprises one of the above seed coating compositions wherein the binder comprises the group of one or more of molasses, corn syrup, sorghum, and cane syrup.

Another exemplary seed coating composition comprises one of the above seed coating compositions wherein the inner coating stabilizing layer is approximately 5 wt % to 10 wt % of the weight of the uncoated seed.

Another exemplary seed coating composition comprises one of the above seed coating compositions wherein the water-absorbing additive is approximately 1 wt % to 3 wt % of the weight of the uncoated seed, and more preferably around 2 wt % of the weight of the uncoated seed.

Another exemplary seed coating composition comprises one of the above seed coating compositions wherein the pericarp of the seed is coated with one or more agents to form a coated seed before the inner coating stabilizing layer is applied.

Another exemplary seed coating composition comprises one of the above seed coating compositions wherein the pericarp of the seed is coated with one or more agents to form a coated seed before the inner coating stabilizing layer is applied, and wherein additional seed coating layers are applied to the coated seed before the inner coating stabilizing layer is applied.

Another exemplary seed coating composition comprises one of the above seed coating compositions wherein additional seed coating layers comprising one or more agents are be applied to the coated seed after the application of the layer of water-absorbing additive.

Another exemplary seed coating composition comprises one of the above seed coating compositions wherein the seed coating composition further comprises at least one additive.

Another exemplary seed coating composition comprises one of the above seed coating compositions wherein the seed coating composition comprises at least one of the following additives: Rhizobium bacteria, MYCO SEED TREAT®, nutrient components, pesticides, fungicides, herbicides, buffers, biologicals to protect a developing seedling, fillers, agrochemicals, beneficial elements, zeolites, and plant growth regulators.

Another exemplary seed coating composition comprises one of the above seed coating compositions wherein the seed coating composition further comprises at least one filler.

Another exemplary seed coating composition comprises one of the above seed coating compositions wherein the seed coating composition further comprises at least one filler, wherein the at least one filler includes limestone.

Another exemplary seed coating composition comprises a combination of one or more of the above seed coating compositions.

A second exemplary seed coating composition comprises applying to the pericarp of a seed a binder until the seed has become saturated with the binder. Preferably, the binder is a liquid binder.

Once the seed has become saturated with the binder, a clay mineral is layered onto the binder coated seed to create an inner coating stabilizing layer. Preferably, the clay mineral is applied to the binder coated seed along with additional binder. Preferably, the coating of clay mineral comprises an effective amount of clay mineral to decrease the occurrence of dusting. Preferably, the clay mineral is bentonite. Preferably, the bentonite is powdered. Alternatively, the one or more clay minerals could be mixed with the binder before application. Alternatively, one or more layers of clay minerals, water-absorbing additives, fillers, and/or additives could be added to the seed before the clay mineral is added.

The amount of clay mineral applied to the binder coated seed is preferably 5 wt % to 10 wt % of the weight of the uncoated seed, but could be more or less than that amount.

Once the desired amount of clay mineral is applied to the seed to form a coated seed, a quantity of water-absorbing additive is added to the coated seed. For instance, water-absorbing additive could be sprinkled onto the coated seed. Alternatively, one or more layers of clay minerals, water-absorbing additives, fillers, and/or additives could be added, with or without the application of additional binder, to the seed after the clay mineral is added, but before the water-absorbing additives.

Where the binder is a liquid binder, and the liquid comprises water, preferably the water-absorbing additive is added to the coated seed without additional binder being applied with the water-absorbing additive. This is done to minimize the absorption of water from the liquid binder into the water-absorbing additive.

The amount of water-absorbing additive applied to the coated seed is preferably 1.0 wt % to 3.0 wt % of the weight of the uncoated seed, and more preferably 2.0 wt % of the weight of the uncoated seed, but could be more or less than that amount. Once a desired amount of water-absorbing additive has been added to the coated seed, application of water-absorbing additive ends.

At that point, filler is then applied to the coated seeds until the filler applied no longer adheres to the coated seed. At that time, the application of binder resumes, enabling additional filler to be added to the coated seed. Preferably, the filler comprises limestone. Alternatively, the filler could be mixed with the binder before application. Alternatively, one or more layers of clay minerals, water-absorbing additives, fillers, and/or additives could be added to the seed after the water-absorbing additive was added, but before the filler was added.

The amount of filler applied to the currently coated seed is preferably about an 8% coating (0.09 times the weight of the currently coated seed) to a 75% coating (3.0 times the weight of the currently coated seed), and more preferably about 34% coating (0.5 times the weight of the currently coated seed) to about a 50% coating (1.0 times the weight of the currently coated seed), but could be more or less than that amount. The coating percent listed is not determined with respect to the uncoated seed weight, but is instead determined with respect to the currently coated seed weight before application of the filler. Once the desired amount of filler has been added to the coated seed, the coating process ends. After the coating process ends, the seeds are compacted, and then are moved to a drying apparatus where the seeds are dried.

Alternatively, one or more layers of clay minerals, water-absorbing additives, fillers, and/or additives could be added to the seed after the filler was added.

The total amount of binder applied in an exemplary seed coating composition will vary based on the species of seed coated, and will vary based on the amounts of coatings applied to the seeds. An average application will use binder to clay mineral/water-absorbing additives/fillers/additives ratios from 1:3 to 1:6.

The preferred binder is a 10 wt % solution in water (100 g of binder is 90% water and 10% polymer). When the binder dries on the coated seed, less than 10% of the weight of the total binder applied will remain due to evaporation of the water and the fact that not all of the binder applied will stick to the uncoated seed/coated seed.

A third exemplary seed coating composition, dry on seed, comprises: about 5 wt % to about 10 wt % of the weight of the uncoated seed of at least one clay mineral, preferably about 5 wt % of the weight of the uncoated seed; about 1 wt % to about 3 wt % of the weight of the uncoated seed of at least one water-absorbing additive, preferably about 2.0 wt % of the weight of the uncoated seed; about 1 wt % to about 5 wt % of the weight of the uncoated seed of at least one binder, preferably about 2.2 wt % of the weight of the uncoated seed; 50 wt % to 150 wt % of the weight of the uncoated seed of at least one filler, preferably 100 wt %; and 0 wt % to 10 wt % of the weight of the uncoated seed of one or more additives, preferably 4.2 wt % of the weight of the uncoated seed.

A fourth exemplary seed coating composition comprises 50% coated alfalfa seed when dry. With 454 g of seed, 454 g of limestone is used (a 1:1 ratio), 10 g of binder (when dry, applied as 100 g of liquid binder (90% water, 10% polymer binder), 5.44 g of inoculant as an additive, 9.08 g (2%) of water-absorbing additive, 13.62 g (3%) of MST as an additive, and 22.7 g (5%) clay mineral (bentonite clay). This was a variable application, with the various rates adjusted as needed for the behavior of all the components during the particular lot of seed.

While these are preferred exemplary seed coating compositions, a skilled artisan will be able to select the appropriate components in a exemplary seed coating composition based on various considerations, including the intended use of the seed, the intended seed type(s) with will be used, the intended environment within which the seed will be used, and the equipment and/or accessories with which the seed is intended to be used, among other considerations.

Exemplary coated seeds comprise one of the exemplary seed coating compositions on a seed.

Exemplary methods of using a seed coating composition comprise coating a seed with one of the exemplary seed coating compositions.

Exemplary seed manufacturing process comprises coating a seed with one of the exemplary seed coating compositions.

Exemplary methods for producing seeds comprise coating seeds with one of the exemplary seed coating compositions.

A first exemplary process of coating seeds comprises coating seeds with one of the exemplary seed coating compositions.

A second exemplary process of coating seeds with one of the exemplary seed coating compositions, comprises the steps of providing a quantity of seeds, coating the seeds with a binder, coating the seeds with a quantity of at least one clay mineral, coating the seeds with a quantity of water-absorbing additive, coating the seeds with a filler, compacting the coated seeds, drying the coated seeds, and screening the dried, coated seeds.

A third exemplary process of coating seeds with one of the exemplary seed coating compositions utilizes two phases, a wet phase and a dry phase. In the wet phase of coating, a liquid binder is introduced to the seed. After coating the seed with at least one binder, at least one clay mineral is introduced to the mixture with an additional quantity of liquid binder, and the mixture is further mixed. Then a water-absorbing additive is introduced to the mixture, and the mixture is further mixed. Then a filler is introduced to the mixture, and the mixture if further mixed. Then additional filler is introduced along with additional binder to the mixture and the mixture is further mixed. The resulting mixture is then transferred to a processing line for the compacting of the coated seed, and to start the dry phase. The wet mixture is rolled within an inclined “rolling” drum, to compact the coating on the seed. After mixing, the coated seed is dried. A heated fluid bed drier, or other drying apparatus/process, can be utilized in this step. The binder hardens during the drying process, ensuring a durable coating. To arrive at a uniform product after drying, the dried seed is screened to remove any remaining dust that did not adhere to the seed coat, and any agglomerated seeds or coating material. After screening, the coated seed is then bagged for shipment and sales.

In a fourth exemplary process of coating seeds, one or more ROTOSTAT® emulsifiers are used. The ROTOSTAT® emulsifiers incorporate a rotating pan at the bottom of a vertical cylinder. The pan throws the seed against the inside wall of the cylinder, and as the seed rolls around the wall, atomized binder is applied from a spinning disk in the center of the cylinder. After coating the seed with the binder, finely ground bentonite powder is then applied, for instance, by a hopper located above the cylinder, additional binder is added, and the mixture is further mixed. As the seed rolls around the inside wall of the cylinder, the coating is packed on the seed. Then, water-absorbing additive is applied, for instance, by a hopper located above the cylinder, and the mixture is further mixed. Then, filler is applied, for instance, by a hopper located above the cylinder, and the mixture is further mixed. Then additional filler is applied, for instance, by a hopper located above the cylinder, along with additional binder, and the mixture is further mixed. After mixing, the cylinders drop the coated seeds into a surge hopper with a belt on the bottom, conveying the seeds to a series of fluid bed dryers, or other drying apparatus/process, with individually controlled temperatures wherein the coated seeds are dried. The binder hardens during the drying process, ensuring a durable coating on the seeds. To arrive at a uniform product after drying, the dried seeds are screened to remove any remaining dust that did not adhere to the seed, and to remove any agglomerated seeds or coating material. After screening, the coated seeds are then bagged for shipment and sales.

A fifth exemplary process of coating seeds, comprises the steps of: providing a quantity of seeds; coating the seeds with a binder to create coated seeds; coating the coated seeds with a clay mineral and additional binder; coating the seeds with a water-absorbing additive; coating the seeds with a filler; coating the seeds with a filler and additional binder; compacting the coated seeds; and drying the coated seeds. Preferably, the coatings comprise about 5 wt % of the weight of the uncoated seed of the clay mineral; about 2 wt % of the weight of the uncoated seed of the water-absorbing additive; and about 100 wt % of the weight of the uncoated seed of the filler. Further preferably, the clay mineral is bentonite clay, the water-absorbing additive is superabsorbent polymer, and the filler is limestone.

Other types of mixing devices/equipment include container mixing, horizontal paddle style batch mixers, rotating disc inside an unmoving cylinder mixers, spray mixers, agitators, ribbon blenders, drum mixers, and combinations of the same. While many different mixing devices and equipment types are mentioned above, a skilled artisan will be able to select appropriate equipment or combination of equipment used in a process according to a particular embodiment based on various considerations, including the environment within which the coated seed is intended to be used, and the components of the coated seeds. Materials, equipment and processes hereinafter discovered and/or developed that are determined to be suitable for use in creating coated seeds would also be considered suitable for use in an exemplary process.

It is noted that all formulas and compositions of the various described embodiments can be combined in any suitable configuration for inclusion in a seed coating according to a particular embodiment. For example, a seed coating according a particular embodiment can include neither, one, or both of a binder and the additives described above.

Any suitable agents can be used to form the various components of the seed coating, and a skilled artisan will be able to select appropriate materials for a seed coating according to a particular embodiment based on various considerations, including the intended seed type(s) with which the composition will be used, the intended environment within which the composition will be used, and the equipment and/or accessories with which the composition is intended to be used. Materials hereinafter discovered and/or developed that are determined to be suitable for use in seed coating compositions would also be considered suitable for use in a seed coating composition according to a particular embodiment.

### EXAMPLE

### Absorption and Durability Study

The objectives of this study were to (1) measure the amount of water coated turf-type tall fescue and Alfalfa seeds absorb, (2) determine the most effective materials and application timing for the highest absorption rates, and (3) assess and quantify the durability of coating between each coated seed sample.

The study utilized superabsorbent polymer (SAP). Four different treatments were used in this study: the Pinnacle treatment, the SAP treatment, the Bentonite treatment, and the SAP/Bentonite treatment.

In the Pinnacle treatment, grey limestone was used as the filler and polyvinyl alcohol (PVOH) (9% solid solution) as the adhesive.

In the SAP treatment, grey limestone was used as the filler and polyvinyl alcohol (PVOH) (9% solid solution) as the adhesive. The SAP was applied at a 2% rate.

In the Bentonite treatment, grey limestone was used as the filler and polyvinyl alcohol (PVOH) (9% solid solution) as the adhesive. The bentonite was applied at a 10% rate.

In the SAP/Bentonite treatment, grey limestone was used as the filler and polyvinyl alcohol (PVOH) (9% solid solution) as the adhesive. The bentonite was applied at a 5% rate, and the SAP was applied at a 2% rate.

Using the four treatments above, the turf-type tall fescue seeds were coated at a 1:1 seed to coat ratio, and the alfalfa seeds were coated at a 0.5:1 coating to seed ratio.

The first method of testing, “Scott's Saturated Incline Test,” was used in Tests A and B to measure the amount of water absorbed by the coated seed. This method included a 4 inch by 4 inch (roughly 10.2 cm by 10.2 cm) screen, and a 2.0 gram seed sample spread evenly in the center of the screen. Enough water was added to the seed to saturate the entire sample. The saturated sample was given one minute to absorb water. The screen was then placed at a forty five degree angle to allow excess water to drain for five minutes. Remaining water, separated from the sample, was dried off with a paper towel. The sample was then re-weighed and the results were recorded.

Test A was Scott's Saturated Incline Test on turf-type tall fescue seed.

Test A Results
Average Intake (grams)

| Dry | Wet | Standard | | | SAP with |
|---|---|---|---|---|---|
| Weight | Weight | Pinnacle | SAP | Bentonite | Bentonite |
| 28.322 | 28.991 | 0.669 | | | |
| 28.264 | 30.631 | | 2.367 | | |
| 28.303 | 30.299 | | | 1.996 | |
| 28.537 | 31.883 | | | | 3.346 |

Test B was Scott's Saturated Incline Test on alfalfa seed.

Test B Results
Average Intake (grams)

| Dry | Wet | Standard | | | SAP with |
|---|---|---|---|---|---|
| Weight | Weight | Pinnacle | SAP | Bentonite | Bentonite |
| 28.221 | 29.094 | 0.873 | | | |
| 28.201 | 31.903 | | 3.702 | | |
| 28.092 | 29.447 | | | 1.355 | |
| 28.033 | 31.445 | | | | 3.412 |

The second method of testing, “Steve's 180 Vertical Absorption Test,” was used in Tests C and D to measure the amount of water absorbed by the coated seed. This method included a 100 ml measuring cylinder, and a 1.5 inch (3.81 cm) diameter funnel with a rubber stopper. The cylinder was placed on the scale and its weight was tared. Then, 2.0 grams of seed was added to the funnel. With the rubber stopper in place, 4.0 grams of water was then applied to the seed. Five minutes after the water was introduced to the seed, the rubber stopper was pulled, allowing any un-absorbed water to drain into the measuring cylinder. The weight of the water was then subtracted from the weight of water initially applied, and the results were recorded.

Test C was Steve's 180 Vertical Absorption Test on turf-type tall fescue seed.

Test C Results
Average Intake (grams)

| Dry | Wet | Standard | | | SAP with |
|---|---|---|---|---|---|
| Weight | Weight | Pinnacle | SAP | Bentonite | Bentonite |
| 21.797 | 22.012 | 0.215 | | | |
| 21.809 | 24.621 | | 2.812 | | |
| 21.797 | 22.938 | | | 1.141 | |
| 21.798 | 25.132 | | | | 3.334 |

Test D was Steve's 180 Vertical Absorption Test on alfalfa seed.

Test D Results
Average Intake (grams)

| Dry | Wet | Standard | | | SAP with |
|---|---|---|---|---|---|
| Weight | Weight | Pinnacle | SAP | Bentonite | Bentonite |
| 21.711 | 22.445 | 0.734 | | | |
| 21.746 | 24.806 | | 3.060 | | |
| 21.777 | 23.714 | | | 1.937 | |
| 21.799 | 25.702 | | | | 3.903 |

The third method of testing, “Scott's Durability Test,” was used in Test E and Test F to test durability. This method included a “Tornado” Paint Shaker, a one gallon (3.8 L) empty paint can, 11.0 lbs (176 ounces) of coated seed, and a mesh screen. The seed was weighed and then multiplied by the percentage of coating and recorded. For instance, 454 grams coated seed multiplied by 50% coating=227 grams coating material. The seed was then placed in a small bag, replicating the type of bag grass seed and some alfalfa is packaged in. This bag of seed was placed inside the empty paint canister and then shaken for two minutes. The seed was then poured from the bag to the mesh screen and vigorously screened for another minute. The fines were collected from screening process and then weighed and recorded. The weight of the fines was divided by the recorded amount of coating on the original sample to calculate the percentage of coating lost. For instance, 1.12 grams of fines from 227 grams of coating material=0.5% loss.

Test E was Scott's Durability Test on turf-type tall fescue seed.

Test E Results
(percentage of loss)

| Coated | | Coating | | | | | |
|---|---|---|---|---|---|---|---|
| Seed | Coating | Material | | Standard | | | SAP with |
| Weight | Percent | Amount | Fines | Pinnacle | SAP | Bentonite | Bentonite |
| 400 | 50% | 200 | 1.67 | 0.84% | | | |
| 390 | 50% | 195 | 0.55 | | 0.28% | | |
| 460 | 50% | 230 | 0.70 | | | 0.30% | |
| 425 | 50% | 212.5 | 1.12 | | | | 0.53% |

The Test E Results show that: (1) the coating washed away very easily in the Pinnacle group, (2) the coating was durable in the SAP group, (3) the coating stayed on the seed in the Bentonite group, and (4) the coating did not wash away but was stripped from the powerful SAP in the SAP with Bentonite group.

Test F was Scott's Durability Test on alfalfa.

Test F Results
(percentage of loss)

| Coated | | Coating | | | | | |
|---|---|---|---|---|---|---|---|
| Seed | Coating | Material | | Standard | | | SAP with |
| Weight | Percent | Amount | Fines | Pinnacle | SAP | Bentonite | Bentonite |
| 500 | 34% | 170 | 0.61 | 0.36% | | | |
| 420 | 34% | 142.8 | 0.56 | | 0.39% | | |
| 480 | 34% | 163.2 | 0.15 | | | 0.09% | |
| 530 | 34% | 180.2 | 1.3 | | | | 0.72% |

The Test F Results show that (1) the coating washed away very easy in the Pinnacle group, (2) the SAP began to strip the coating in the SAP group, (3) most of the coating stayed on the seed in the Bentonite group, and (4) the SAP was very strong in the sample and stripped the limestone from the seeds in the SAP with Bentonite group.

The foregoing detailed description provides exemplary embodiments of the invention and includes the best mode for practicing the invention. The description and illustration of these embodiments is intended only to provide examples of the invention, and not to limit the scope of the invention, or its protection, in any manner.

What is claimed is:

1. A coated seed comprising:
a seed, and a seed coating on said seed,
wherein said seed coating comprises an inner coating layer comprising a clay mineral; and
wherein said seed coating comprises an outer coating layer comprising a water-absorbing additive.

2. The coated seed of claim 1, wherein said clay mineral comprises bentonite.

3. The coated seed of claim 1, wherein said water-absorbing additive comprises a superabsorbent polymer.

4. The coated seed of claim 1, wherein said seed coating further comprises a binder for binding the seed coatings to the seed.

5. The coated seed of claim 1, wherein said seed coating further comprises a later coating of at least one filler.

6. The coated seed of claim 5, wherein said filler is limestone.

7. The coated seed of claim 5, wherein said seed coating comprises:
about 5 wt % of the weight of the seed of said clay mineral;
about 2 wt % of the weight of the seed of said water-absorbing additive; and
about 100 wt % of the weight of the seed of said filler.

8. The coated seed of claim 7, further comprising about 0 wt % to about 2 wt % of the weight of the seed of at least one additive selected from the group consisting of: Rhizobium bacteria, nutrient components, pesticides, fungicides, herbicides, buffers, biologicals, agrochemicals, beneficial elements, zeolite, soil surfactants, vitamins, cofactors, penetrants, water absorbants, mold inhibitors, soil conditioners, carbohydrates, acids, and plant growth regulators.

9. The coated seed of claim 7, further comprising about 2 wt % of the weight of the seed of at least one additive selected from the group consisting of: glues, stickers, water soluble adhesives, molasses, corn syrup, sorghum, cane syrup, polyvinyl alcohol, polyvinyl acetate, Arabic gums, polyvinyl pyrrolidone, calcium lignosulfonate, and synthetic organic polymers.

10. The coated seed of claim 1, wherein said clay mineral comprises bentonite, wherein said water-absorbing additive comprises a superabsorbent polymer, and wherein said coated seed further comprises a later coating layer of limestone.

11. The coated seed of claim 1, wherein said seed coating further comprises at least one additive selected from the group consisting of: Rhizobium bacteria, nutrient components, pesticides, fungicides, herbicides, buffers, biologicals, agrochemicals, beneficial elements, zeolite, soil surfactants, vitamins, cofactors, penetrants, water absorbants, mold inhibitors, soil conditioners, carbohydrates, acids, and plant growth regulators.

12. The coated seed of claim 1, further comprising a binder for binding the seed coatings to the seed, wherein said binder comprises at least one binder selected from the group consisting of: glues, stickers, water soluble adhesives, molasses, corn syrup, sorghum, cane syrup, polyvinyl alcohol, polyvinyl acetate, Arabic gums, polyvinyl pyrrolidone, calcium lignosulfonate, and synthetic organic polymers.

13. The coated seed of claim 1, wherein said seed coating comprises about 5 wt % to about 10 wt % of the weight of the seed of said clay mineral, and about 1 wt % to about 3 wt % of the weight of the seed of said water-absorbing additive.

14. A coated seed comprising:
a seed;
a first seed coating layer on said seed comprising a binder;
a second seed coating layer on said seed comprising a clay mineral;
a third seed coating layer on said seed comprising a water-absorbing additive;
a fourth seed coating layer comprising a filler; and
a fifth seed coating layer comprising a filler and a binder.

15. The coated seed of claim 14, wherein said clay mineral is bentonite clay, wherein said water-absorbing additive is superabsorbent polymer, and wherein said filler is limestone.

16. The coated seed of claim 14, wherein said coated seed comprises about 5 wt % to about 10 wt % of the weight of the seed of said clay mineral, about 1 wt % to about 3 wt % of the weight of the seed of said water-absorbing additive, and about 50 wt % to about 150 wt % of the weight of the then coated seed of said filler.

17. The coated seed of claim 16, wherein said binder comprises about 1 wt % to about 5 wt % of the weight of the seed.

18. A process of coating seeds, comprising the steps of:
providing a quantity of seeds;
coating said seeds with a binder to create coated seeds;
coating said coated seeds with a clay mineral and additional binder;
coating said coated seeds with a water-absorbing additive;
coating said coated seeds with a filler;
coating said coated seeds with additional filler and additional binder;
compacting the coated seeds; and
drying the coated seeds.

19. The process of coating seeds of claim 18, wherein said seed coatings comprises:
clay mineral in the amount of about 5 wt % to about 10 wt % of the weight of the uncoated seed;
water-absorbing additive in the amount of about 1 wt % to about 3 wt % of the weight of the uncoated seed; and
filler in the amount of about 8 wt % to about 75 wt % of the current weight of the coated seed.

20. The process of coating seeds of claim 18, wherein said clay mineral is bentonite clay, wherein said water-absorbing additive is superabsorbent polymer, and wherein said filler is limestone.
